(19) United States
(12) Patent Application Publication
(10) Pub. No.: US 2003/0194282 A1
(43) Pub. Date: Oct. 16, 2003

(54) Tool bit for clamshell lathe

(76) Inventor: Richard Majerus, Mazzepa, MN (US)

Correspondence Address: NIKOLAI & MERSEREAU, P.A., 900 SECOND AVENUE SOUTH, SUITE 820, MINNEAPOLIS, MN, 55402, US

(21) Appl. No.: 10/122,777

(22) Filed: Apr. 15, 2002

(51) Int. Cl. B23B 27/22; B23P 15/28

(52) U.S. Cl. 407/114; 407/116

(57) ABSTRACT

A tool bit for a clamshell machining lathe for cutting and finishing pipes, including a base, neck and top surface. The base of the tool bit is shaped to fit into the slide block of the lathe. The cutting edge of the tool bit creates a chip which is then spilt into three different parts by a central rib running along the top surface of the tool bit. The chips then run along an arcuate notch as they fall away from the tool bit so as not to interfere with the cutting of the pipe.

### BACKGROUND OF THE INVENTION

I. Field of the Invention

This invention relates generally to a tool bit used in a machining lathe, and more particularly one that is used in a split frame clamshell-type portable machining lathe for cutting and finishing relatively large diameter pipes.

II. Description of the Prior Art

Split frame clamshell lathes are known in the art. Such machines require a cutting tool, which is moved in a radial direction against the pipe to be machined in incremental steps upon each revolution of the ring gear. For those wishing more information on the type of machining apparatus on which the present invention finds uses, reference may be had at U.S. Pat. No. 5,549,024, the teachings of which are hereby incorporated by reference.

A problem has existed in the prior art where the tool bits either become too dull to machine the pipe, or break after relatively short use. An exemplary tool bit is shown in FIG. 1. It is especially noted that the top surface 2 of the tool bit is flat as it leaves the cutting edge 4. The primary cause of the wear and breakage problem is the creation of metal chips or shavings. When the prior art tool bit is used, a long, curled chip, which is approximately 0.25″ wide is created when the cutting edge 4 of the tool bit is forced against the work-piece, such as the pipe or shaft. As the tool bit machines the pipe, the chips or shavings tend to be a long, continuous, curled strip which tends to interfere with the cutting edge of the tool bit or the cutting path of the lathe. The chips either roll up on the cutting edge of the tool bit, or get wedged in the cutting path. As the chip creates friction with the cutting edge of the tool bit, the resulting heat intensifies rendering the tool more brittle and likely to chip the cutting edge. Also, more power is required to maintain the cut and the tool life is reduced.

### Objects

It is accordingly a principal object of the present invention to provide an improved tool bit for use in a split frame clamshell pipe lathe.

Another object of this invention is to provide a tool bit which will avoid unnecessary friction and heat buildup by preventing metal chips from interfering with the cutting edge of the tool bit or getting wedged in the cutting path.

### SUMMARY OF THE INVENTION

The foregoing objects and features of the invention are achieved by providing an improved tool bit for use in a clamshell machining lathe for cutting or finishing pipes. The tool bit comprises a base portion and a top portion having a top surface. The base is a rectangular block which is shaped and adapted to be clamped in a radially moveable slide block on a clamshell lathe. The top portion extends upward from the top of the base. The top portion is thinner than the base, and an arcuate recess if formed across the tool's width at the top surface of the top portion to define a cutting edge. The arcuate recess provides a relief space for receiving the chips and shavings created by use of the tool bit. Tapering laterally outward, and running along the top surface of the tool from its cutting edge to its trailing edge is a central rib which is used to break the metal shavings and chips into three separated parts. Breaking the chip into three parts ensures that the chip won't interfere with the cutting edge or the cutting path as the tool bit is used to machine a work-piece.

### DESCRIPTION OF THE DRAWINGS

FIG. 1 illustrates a prior art tool bit for use in a clamshell pipe lathe;

FIG. 2 is a perspective view of the tool bit constructed in accordance with the present invention;

FIG. 3 is a top view of the tool bit showing the tapering of the central rib; and

FIG. 4 is side view of the tool bit.

### DESCRIPTION OF THE PREFERRED EMBODIMENT

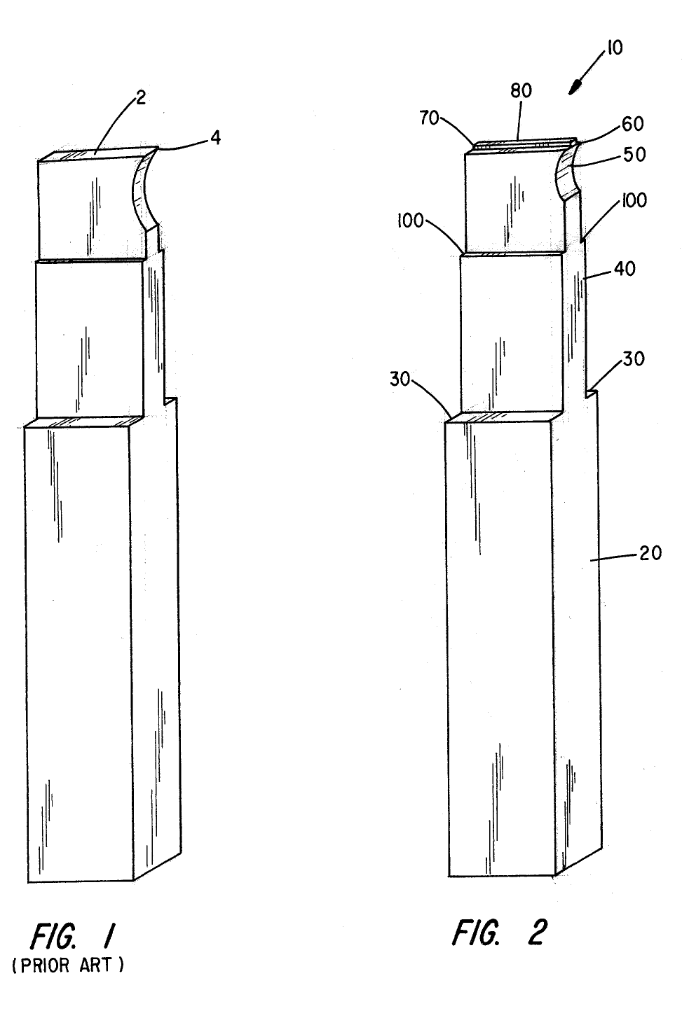

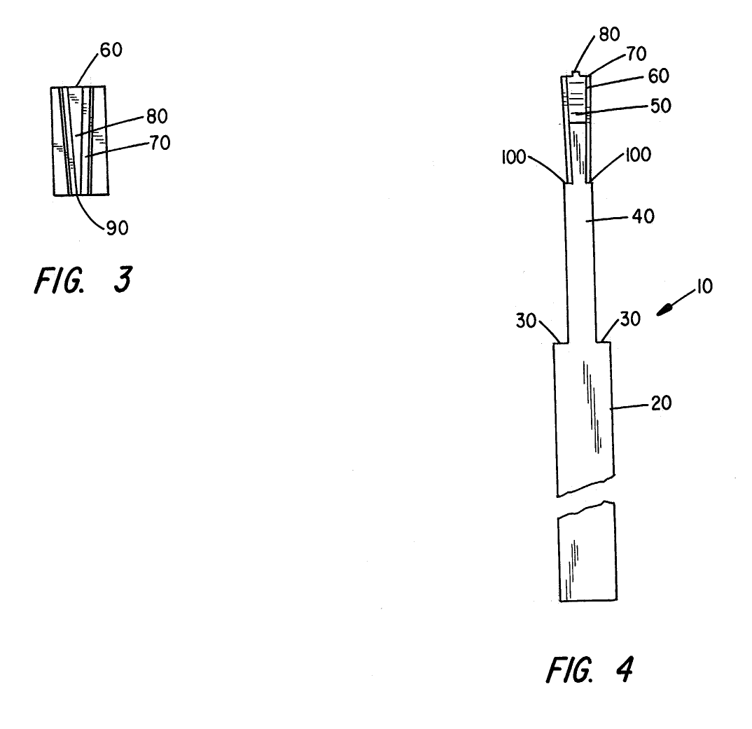

FIG. 2 shows a side view of the tool bit for used in a clamshell pipe cutting lathe, such as the one disclosed in U.S. Pat. No. 5,549,024. It is indicated generally by numeral 10. A base portion 20 of the tool bit 10 is manufactured to be inserted and fit into a slide block on the clamshell lathe. The base 20 has a rectangular cross section. Without limitation, the base 20 may be 4.375″ long, 0.5″ thick, and 1.0″ wide. The entire tool bit 10 is constructed entirely of tool steel but may have a carbide impregnated cutting edge. The tiering of the thickness of the tool bit 10 provides strength at the base while at the same time allowing adequate clearance for the chips to fall away from the tool bit as they are formed.

Extending from the top shoulder 30 of the base 20 and extending upward is a neck 40. The neck may be approximately 2.5″ long and 1.0″ deep. For a length of 1.5″ from the shoulder 30, an intermediate portion of the neck 40 is preferably about 0.25″ thick from its front edge to its rear edge. Starting from a second shoulder 100, the top portion of the neck 40 rises another approximately 0.375″ with a thickness of 0.200″ and tapers up to 0.250 at the cutting edge 60. As the neck 40 extends upward a arcuate notch 50 is formed inwardly of the tools leading edge to receive the chips as the tool bit 10 machines a pipe or shaft that is centered in the clamshell lathe. The top of the arcuate notch 50 is the cutting edge 60 of the tool bit 10.

Running along the top surface 70 of the tool bit 10 is a central rib 80. The central rib 80 tapers laterally inward from the cutting edge 60 to the trailing edge 90, preferably at an angle of about 1 degree. When the tool bit 10 is clamped in the lathe's slide block, the tool bit 10 will be made to orbit the pipe that is to be finished. The tool bit 10 is then advanced in incremental steps against the pipe. As the cutting edge 60 of the tool bit 10 engages the pipe, it creates metal chips. The central rib 80 functions to divide the metal chip into three narrower chips. With dimensions provided, two chips will be about 0.062 inches wide and the third will be about 0.125 inches wide. The three chips then gather in the arcuate notch 50 and are dispersed so as not to interfere with the cutting edge's contact with the pipe.

Because the central rib 80 first engages the work-piece followed later by the portions of the tool on either side of the central rib 80, less metal is being removed on each orbit, thereby reducing the frictional heating of the tool and prolonging its useful life. Also, less downtime is experienced since the cutting tool 10 remains serviceable over longer periods of use.

This invention has been described herein in considerable detail in order to comply with the Patent Statutes and to provide those skilled in the art with the information needed to apply the novel principles and to construct and use such specialized components as are required. However, it is to be understood that the invention can be carried out by specifically different equipment and devices, and that various modifications, both as to equipment details and operating procedures, can be accomplished without departing from the scope of the invention itself.

What is claimed is:

1. A cutting tool bit for a clamshell lathe comprising:
a) a block of tool steel having a rectangular cross section along the length thereof, the block having a base portion, and a top portion, where a width dimension of the base portion is greater than a width dimension of the top portion;
b) an arcuate recess formed across the width dimension of the top portion and extending a predetermined distance along a length dimension of the top portion from a top surface of the top portion to create a cutting edge; and
c) a central rib projecting out from the top surface of the top portion and extending from the cutting edge substantially an entire depth dimension of the top portion.

2. The cutting tool bit in claim 1 wherein the raised projection has a width that tapers laterally inward along its length starting at the cutting edge.

3. The cutting tool bit as in claim 1 and further including an intermediate portion between the base portion and the top portion, a width dimension of the intermediate portion being less than that of the base portion and greater than that of the top portion.

4. The cutting tool bit as in claim 1 wherein a length dimension of the cutting tool bit is in a range of from 6.5 inches to 8.5 inches and the depth dimension is in a rage of from 0.75 inches to 1.5 inches.

5. The cutting tool bit of claim 4 wherein the width dimension of the base portion is in a range of from 0.25 inch to 0.75 inch.

6. The cutting tool bit of claim 5 wherein the width dimension of the top portion is in a range of from 0.2 to 0.3 inches.

7. The cutting tool bit of claim 1 wherein the central rib projects out about 0.031 inch from said top surface.

8. The cutting tool bit as in claim 2 wherein an angle of taper of the central rib is about 1 degree and the width is about 0.125 inch at said cutting edge.
